(19) United States
(12) Patent Application Publication
(10) Pub. No.: US 2014/0225388 A1
(43) Pub. Date: Aug. 14, 2014

(54) LATCH RELEASE MECHANISM

(71) Applicant: United Technologies Corporation, Hartford, CT (US)

(72) Inventor: David F. Sandy, Milford, CT (US)

(73) Assignee: United Technologies Corporation, Hartford, CT (US)

(21) Appl. No.: 14/156,653

(22) Filed: Jan. 16, 2014

Related U.S. Application Data
(60) Provisional application No. 61/763,116, filed on Feb. 11, 2013.

(51) Int. Cl. E05B 15/02; F01D 25/24

(52) U.S. Cl. CPC E05B 15/0205; F01D 25/24
USPC 292/341.17

(57) ABSTRACT

A latch release mechanism which allows disengagement of a door or other structure in the instance where a primary latch becomes jammed.

### CROSS REFERENCE TO RELATED APPLICATIONS

The present application is related to, and claims the priority benefit of, U.S. Provisional Patent Application Ser. No. 61/763,116 filed Feb. 11, 2013, the contents of which are hereby incorporated in their entirety into the present disclosure.

### TECHNICAL FIELD OF THE DISCLOSED EMBODIMENTS

The presently disclosed embodiments generally relate to latching devices and, more particularly, to a latch release mechanism.

### BACKGROUND OF THE DISCLOSED EMBODIMENTS

There are many applications where it is known to provide a latch to retain one structure, such as a door or access panel, in engagement with another structure. The latch normally comprises a latching mechanism on one structure that includes a latch member that engages a latch retaining member on the other structure so that movement between the two structures is restricted. Disengagement of the latch is achieved by moving the latch member so that it no longer engages the retaining member. Occasionally, the latching mechanism fails and the latch member cannot be moved, thereby preventing the door or panel from being opened. There is therefore a need for a device and method for opening a jammed latch.

### BRIEF SUMMARY OF THE DISCLOSED EMBODIMENTS

In one aspect of a latch release mechanism of the present disclosure, the latch release mechanism is adapted to connect to an engine assembly surround, and further comprises a retaining member, a rotatable joint, and an exposed tab. The latch release mechanism is operable in a first position wherein a latch member engages the retaining member such that the latch member is in a latched or closed position. Furthermore, the latch release mechanism is movable to a second position wherein a latch member disengages the retaining member such that the latch member is in an unlatched or open position.

In one embodiment, a latch release mechanism attached to a first structure and operable to engage a latch member attached to a second structure is disclosed, the latch release mechanism comprising: a retaining member for engaging the latch member when the retaining member is in a first position; and a rotatable joint coupling the retaining member to the first structure, the rotatable joint allowing the retaining member to pivot between the first position and a second position; wherein when the retaining member moves from the first position to the second position, the latch member is disengaged from the retaining member.

In another embodiment, a core cowl for a gas turbine engine is disclosed, the core cowl comprising: an opening in the core cowl; a first structure at least substantially covering the opening; latch release mechanism attached to the core cowl and the first structure and operable to engage a latch member attached to another portion of the core cowl and the first structure, the latch release mechanism comprising: a retaining member for engaging the latch member when the retaining member is in a first position; and a rotatable joint coupling the retaining member to said one portion of the core cowl and the first structure, the rotatable joint allowing the retaining member to pivot between the first position and a second position; wherein when the retaining member moves from the first position to the second position, the latch member is disengaged from the retaining member.

In another embodiment, a method for disengaging a first surface including a retaining member engaging a latch member operatively coupled to a second surface when the retaining member is in a first position is disclosed, the method comprising the step of: a) rotating the retaining member from the first position to a second position in which the latch member is not engaged with the retaining member.

Other embodiments are also disclosed.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic view of a gas turbine engine as an exemplary application of the described subject matter;

FIG. 2 shows one embodiment of a latch release mechanism in a first position;

FIG. 3 shows the latch release mechanism of FIG. 2 engaged with a latch member; and

FIG. 4 shows a latch release mechanism of FIG. 2 in a second position.

An overview of the features, functions and/or configuration of the components depicted in the figures will now be presented. It should be appreciated that not all of the features of the components of the figure are necessarily described. Some of these non-discussed features, as well as discussed features are inherent from the figure. Other non-discussed features may be inherent in component geometry and/or configuration.

### DETAILED DESCRIPTION OF THE DRAWINGS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

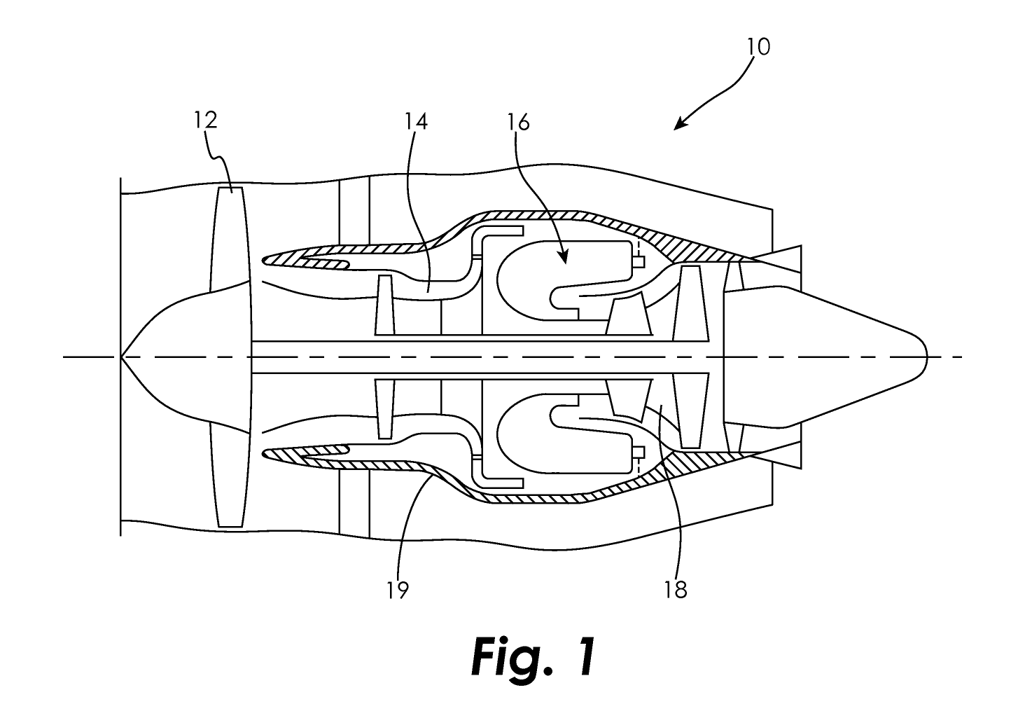

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. A core cowl 19 is provided to enclose the compressor section 14, the combustor 16 and the turbine section 18.

The engine 10 may be provided with one or more access panels or doors in the core cowl 19 that may be held in place with a latching mechanism that may be disengaged by a latch release mechanism. When the primary latch release mechanism fails, the panel or door cannot be opened to gain access to the interior of the core cowl. Therefore, a way is needed to release the latching mechanism to gain entrance through the opening when the primary latch release mechanism fails.

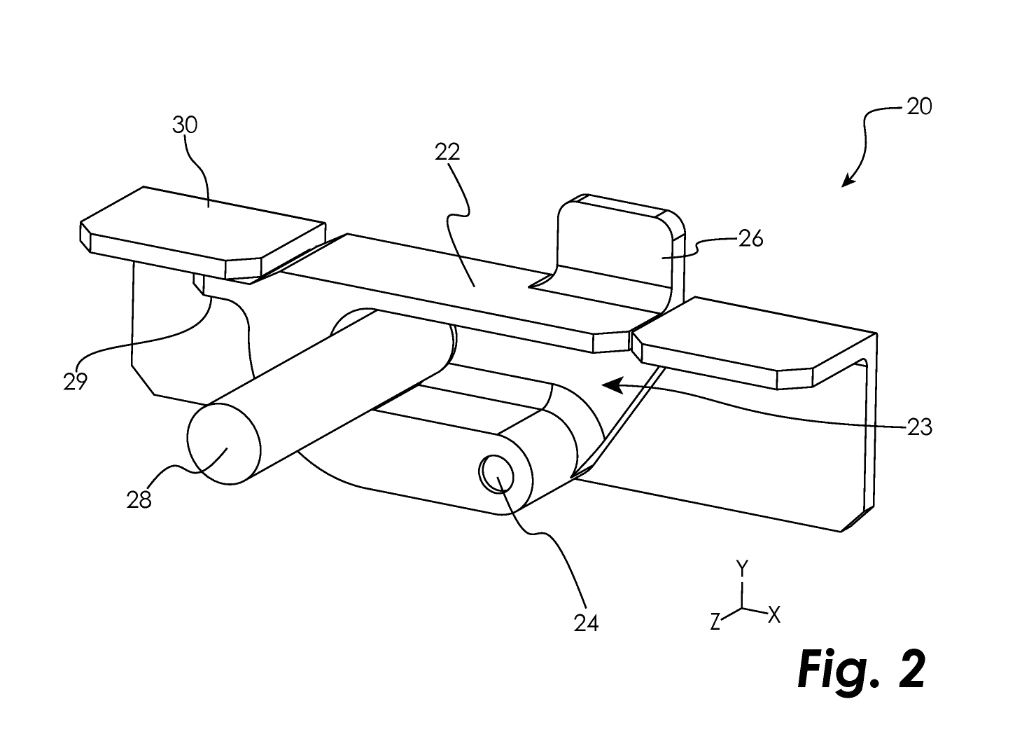

Referring to FIG. 2, one embodiment of a latch release mechanism 20 of the present disclosure is shown in a first position. The latch release mechanism 20 comprises a retaining member 22, a slot 23, a rotatable joint 24, an exposed tab 26, and a bearing tab 29. In some embodiments, the rotatable joint 24 comprises a pin retained within a hole formed in the retaining member 22, wherein one end of the pin is coupled to the structure 30. When the latch release mechanism 20 is in a first position, a latch member 28 engages the retaining member 22 within the slot 23 such that latch member 28 is in a latched or closed position.

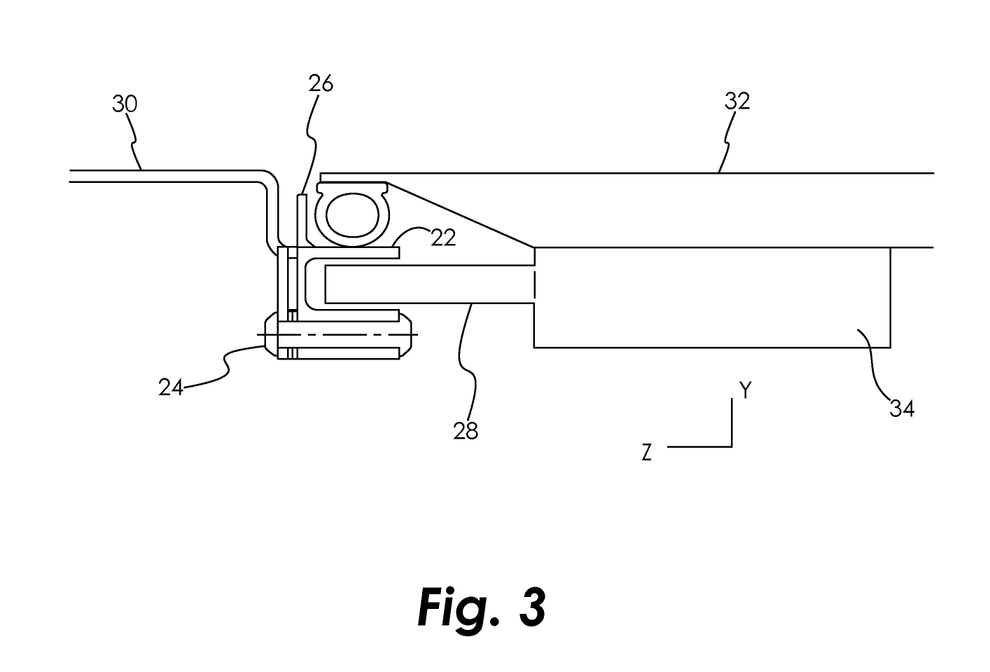

As shown in FIG. 3, the latch release mechanism 20 is adapted to connect to a first structure 30 that is releasably joined to a second structure 32. In one embodiment, the second structure 32 is a door in an engine assembly surround 30, to name just one non-limiting example. It will be appreciated from the present disclosure that the latch release mechanism embodiments disclosed herein will find application in any situation where a latch is used, and are not limited to use with gas turbine engines, these being discussed as just one exemplary application of the presently disclosed embodiments. Interference between the latch member 28 and the retaining member 22 prevents the structure 32 from being moved with respect to the structure 30.

In some embodiments, the two joined structures 30 and 32 are normally separated by movement of the latch member 28 parallel to the z-axis such that latch member 28 disengages the retaining member 22, thereby allowing the structure 32 latch member to move with respect to the structure 30. In some embodiments, the pin 28 is translated parallel to the z-axis by a primary latch release mechanism 34, such as a mechanical or electromechanical linear translation mechanism. There may be instances, however, in which the primary latch release mechanism 34 that is used to translate the latch member 28 in the z-axis direction fails. Upon such failure, the two structures 30, 32 remain joined by the interference between the latch member 28 and the retaining member 22. The presently disclosed latch release mechanism 20 provides a secondary means by which the latch member 28 and retaining member 22 may be disengaged so that the two structures 30, 32 may be moved with respect to one another.

It will be appreciated from the present disclosure that any movement of the structure 32 in the y-axis direction will create a clockwise moment around the rotatable joint 24 which is reacted to by the bearing tab 29 of the retaining member 22 pressing against structure 30, thereby preventing movement of the structure 32 with respect to the structure 30.

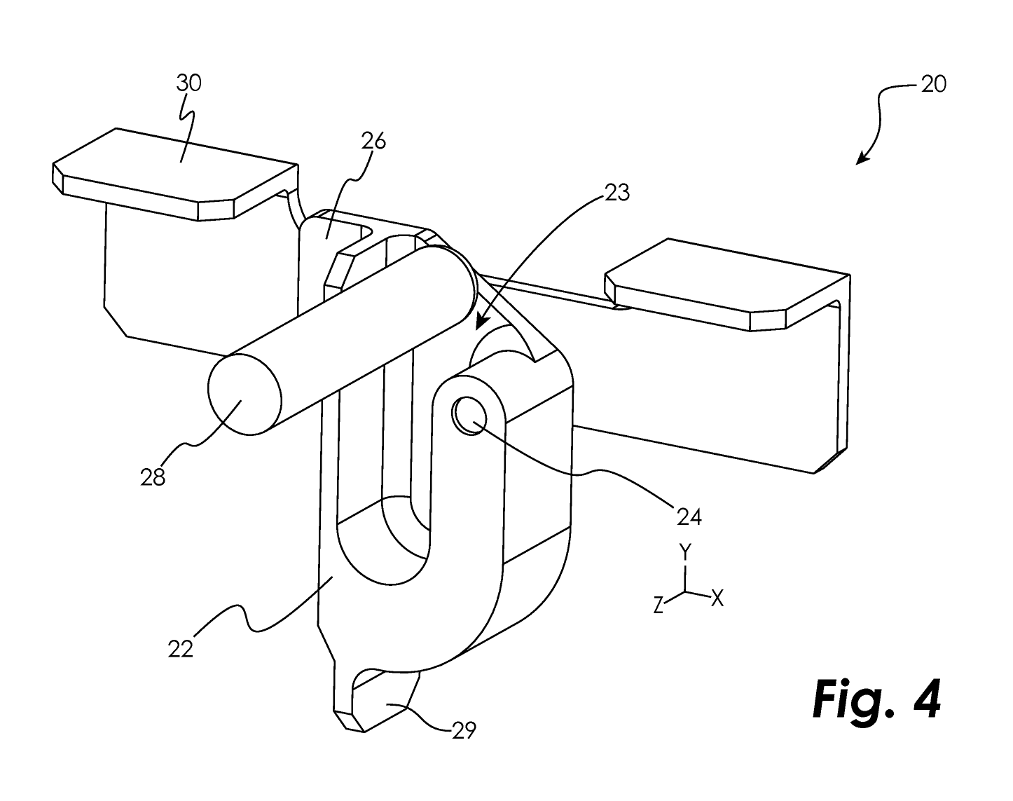

Referring now to FIG. 4, the latch release mechanism 20 of the present disclosure is shown in a second position. Latch release mechanism 20 is placed in a second position by manually pulling exposed tab 26, creating a counter-clockwise moment such that rotatable joint 24 rotates in a counter-clockwise direction. When rotatable joint 24 rotates in a counter-clockwise direction, retaining member 22 rotates to disengage latch member 28 such that latch member 28 is in an unlatched or open position. In this position, the structure 32 may be moved with respect to the structure 30. Latch release mechanism 20 is held in the first position of FIG. 2 during normal operation by a keeper mechanism such as a small detent or spring (not shown) coupled to latch release mechanism 20.

It will be appreciated from the present disclosure that the embodiments disclosed herein provide for a secondary latch release mechanism that does not operate by defeating the primary latch release mechanism. In solving the problem in this manner, the reliability of the primary latch release mechanism may be improved.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A latch release mechanism attached to a first structure and operable to engage a latch member attached to a second structure, the latch release mechanism comprising:
a retaining member for engaging the latch member when the retaining member is in a first position; and
a rotatable joint coupling the retaining member to the first structure, the rotatable joint allowing the retaining member to pivot between the first position and a second position;
wherein when the retaining member moves from the first position to the second position, the latch member is disengaged from the retaining member.

2. The latch release mechanism of claim 1, wherein the retaining member includes a slot for engaging the latch member when the retaining member is in a first position; and
wherein when the retaining member moves from the first position to the second position, the latch member is disengaged from the slot.

3. The latch release mechanism of claim 1, wherein the rotatable joint comprises:
a hole formed in the retaining member; and
a pin disposed in the hole, the pin adapted to be operatively coupled to the first structure.

4. The latch release mechanism of claim 1, wherein the retaining member further includes an exposed tab, wherein movement of the exposed tab causes rotation of the rotatable joint in a first direction.

5. The latch release mechanism of claim 4, wherein the exposed tab is accessible to a user when the retaining member is in the first position.

6. The latch release mechanism of claim 4, wherein the retaining member further comprises a bearing tab, wherein interaction between the bearing tab and the first structure prevents rotation of the rotatable joint in a second direction opposite the first direction.

7. A core cowl for a gas turbine engine, the core cowl comprising:
an opening in the core cowl;
a first structure at least substantially covering the opening;
a latch release mechanism attached to one portion of the core cowl and the first structure and operable to engage a latch member attached to another portion of the core cowl and the first structure, the latch release mechanism comprising:
a retaining member for engaging the latch member when the retaining member is in a first position; and
a rotatable joint coupling the retaining member to said one of the core cowl and the first structure, the rotatable joint allowing the retaining member to pivot between the first position and a second position;
wherein when the retaining member moves from the first position to the second position, the latch member is disengaged from the retaining member.

8. The core cowl of claim 7, wherein the retaining member includes a slot for engaging the latch member when the retaining member is in a first position; and
wherein when the retaining member moves from the first position to the second position, the latch member is disengaged from the slot.

9. The core cowl of claim 7, wherein the rotatable joint comprises:
a hole formed in the retaining member; and
a pin disposed in the hole, the pin adapted to be operatively coupled to said one of the core cowl and the first structure.

10. The core cowl of claim 7, wherein the retaining member further includes an exposed tab, wherein movement of the exposed tab causes rotation of the rotatable joint in a first direction.

11. The core cowl of claim 10, wherein the exposed tab is accessible to a user when the retaining member is in the first position.

12. The core cowl of claim 10, wherein the retaining member further comprises a bearing tab, wherein interaction between the bearing tab and said one of the core cowl and the first structure prevents rotation of the rotatable joint in a second direction opposite the first direction.

13. A method for disengaging a first surface including a retaining member engaging a latch member operatively coupled to a second surface when the retaining member is in a first position, the method comprising the step of:
a) rotating the retaining member from the first position to a second position in which the latch member is not engaged with the retaining member.

14. The method of claim 13, wherein the retaining member includes a slot for engaging the latch member when the retaining member is in the first position; and
wherein step (a) further comprises rotating the retaining member from the first position to the second position, the latch member is disengaged from the slot.
